(19) United States
(12) Patent Application Publication
(10) Pub. No.: US 2009/0139629 A1
(43) Pub. Date: Jun. 4, 2009

(54) Extended-Mobility Tyre Comprising A Flexible Sidewall

(76) Inventors: Guy Cagneaux, Nohanent (FR); Nicolas Janin, Riom (FR)

Correspondence Address: BUCHANAN, INGERSOLL & ROONEY PC, POST OFFICE BOX 1404, ALEXANDRIA, VA, 22313-1404, US

(21) Appl. No.: 11/988,798

(22) PCT Filed: Jul. 5, 2006
(86) PCT No.: PCT/EP2006/006553

§ 371 Date: Jan. 15, 2008

(30) Foreign Application Priority Data
Jul. 19, 2005 (FR) 0507792

(51) Int. Cl. B60C 15/00

(52) U.S. Cl. 152/539

(57) ABSTRACT

A tire for a vehicle wheel, in which at least one of the tire's beads includes: an anchoring zone for anchoring the reinforcement structure and including an upturn of the reinforcement structure around the bead wire, a bearing zone disposed radially and axially external to the bead wire and surrounded by the turned-up portion of the reinforcement structure, and an anchoring closure zone disposed substantially radially to the outside of the bead wire. The location of the anchoring closure zone is defined on one hand by an imaginary bead wire axis (At) which is substantially axial and passes substantially radially externally to the bead wire, and on the other hand an imaginary axis alpha which passes substantially radially externally to the bearing zone. The angle alpha has an angle alpha of less than 50° and preferably less than 45° as measured between the bead wire axis (At) and the axis alpha, in a clockwise direction.

The present invention relates to a tire for a vehicle wheel in which at least one of the beads comprises a seat having a generatrix, the axially inner end of which is located on a circle of diameter greater than the diameter of the circle on which the axially outer end is located. This type of design is particularly suited to the new generations of tires which can be used, within certain limits, in conditions of low pressure, or even zero or virtually zero pressure, with the risk of separation of the tire from the rim on which it is mounted being eliminated. This concept is frequently referred to by the expression “extended mobility”.

For a long time, tire manufacturers have been trying to develop a tire which does not provide any source of risk or potential danger in the event of an abnormal drop in, or even total loss of, pressure. One of the difficulties encountered relates to traveling with a flat tire or at very low pressure, because when traveling at very low pressure, or even at zero pressure, with conventional tires, the beads are liable to separate from the periphery of the rim against which they are held by the pressure.

Numerous solutions have been tested in order to overcome these disadvantages. Frequently, these solutions cause additional difficulties in mounting and demounting the tire on/from the rim.

EP 0 673 324 describes a rolling assembly comprising at least one tire with a radial carcass reinforcement which is anchored within each bead and a rim of specific shaping. This rim comprises a first seat with a generatrix such that the axially outer end of said generatrix is distant from the axis of rotation by a length less than the distance separating its axially inner end and is delimited axially to the outside by a protrusion or rim flange. The tire comprises bead seats suitable for mounting on this rim. The type of tire/rim interface proposed in this document has many advantages compared with the solutions already known, in particular with regard to the ease of mounting/demounting, while making it possible to travel a certain distance despite a drop in pressure.

EP 0 748 287 describes a solution which permits initial optimization of the basic technology described in EP 0 673 324 referred to above. It discloses a tire, at least one bead of which has a structure which makes it possible to modify the clamping of said bead according to the tension of the carcass reinforcement and in particular permitting reinforcement thereof when the inflation pressure increases to its service value. The document thus proposes using a bead with anchoring of the end of the carcass by turning it up about the base of the bead wire, via the axially and radially inner sides relative to the bead wire. The bead also comprises, adjacent to the bead wire and axially to the outside thereof, a profiled element of rubber mix of relatively high hardness against which the bead wire can exert a compressive force when the tension of the carcass reinforcement increases. This compressive force creates self-clamping of the toe of the bead on the mounting rim. The tension of the carcass therefore involves displacement of the bead wire towards the outside, so that the latter generates said compressive force. In such a configuration, the presence of a bead wire of conventional type and the turning-up of the carcass beneath the latter are presented as being indispensable for generating the compressive force. This restricts the possibility of considering other types of arrangement.

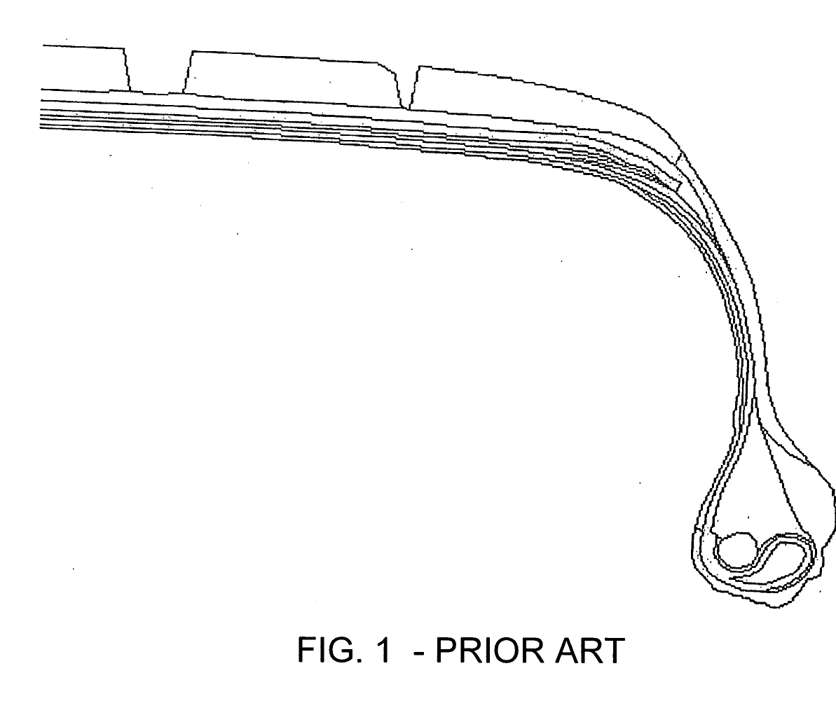

Document WO 95/23073 describes an extended-mobility tire comprising an optimized bottom zone, which provides a good compromise between ease of mounting and resistance to unwedging. FIG. 1 of the present document depicts a well-known embodiment of this bottom zone. According to this arrangement, the zone of the bead located radially externally to the bead wire forms a triangle consisting of a rubber mix of high modulus. This triangle occupies a large portion of the bead and extends radially externally very far beyond the bead wire. The consequence of the presence of this type of anchoring is major stiffening of the bead on one hand and of the sidewall on the other hand. Thus, in operation, the useful portion of the sidewall is reduced.

The present invention therefore proposes to overcome the various disadvantages inherent in the solutions set forth above.

To do this, it provides a tire for a vehicle wheel, comprising:
two sidewalls spaced apart axially from each other, joined at their radially external portions by a crown zone provided on its radially outer portion with a circumferential tread;
beads, arranged radially to the inside of each of the sidewalls, each bead comprising a seat and an outer flange which are intended to come into contact with a suitable rim;
a reinforcement structure extending substantially radially from each of the beads, along the sidewalls, towards the crown zone;
at least one of said beads comprising:
a bead seat comprising a generatrix the axially inner end of which is located on a circle of diameter greater than the diameter of the circle on which the axially outer end is located;
a bead wire;
a zone for anchoring the reinforcement structure in said bead, comprising an upturn of said carcass-type reinforcement structure around said bead wire, radially to the inside thereto, from the axially inner side towards the side axially external to the bead wire;
a bearing zone, radially substantially close to and axially external to said bead wire, said bearing zone consisting of a rubber mix of substantially high modulus (preferably greater than 40 MPa);
an anchoring closure zone, substantially radially to the outside of the bead wire, the location of which is defined on one hand by an imaginary bead wire axis

At, which is substantially axial and passes substantially radially externally to said bead wire, and on the other hand an imaginary axis alpha, which passes substantially radially externally to the bearing zone and has an angle alpha of less than 50° and preferably less than 45°, said angle alpha being measured between the bead wire axis and said axis alpha, in a clockwise direction.

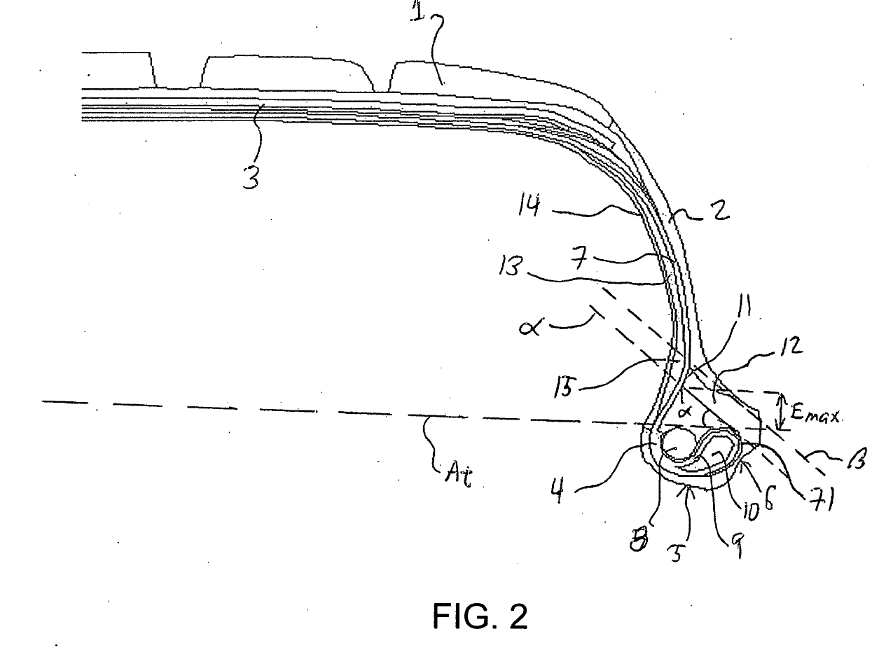

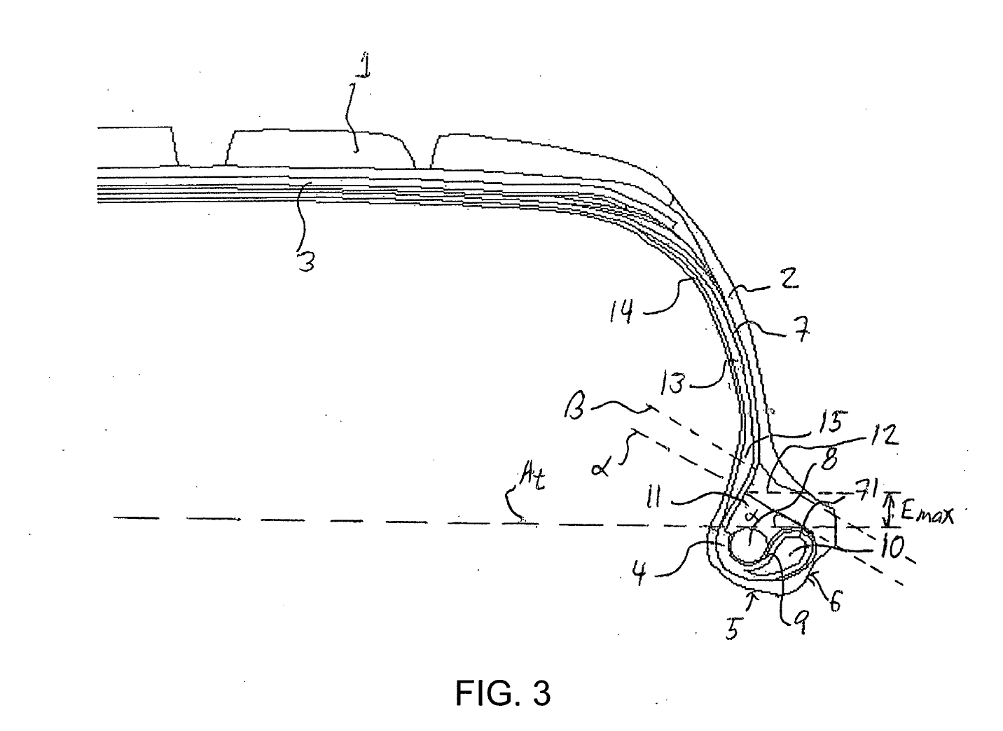

Such an arrangement of the tire makes it possible to increase the level of flexibility of the sidewalls. In practice, the useful portion of the sidewall is increased. Thus it is possible to use the tire with a greater deflection when running under reduced-pressure conditions. Even more preferably, the angle alpha is less than or equal to 40°; for example, in the embodiment of FIG. 2, it is approximately 40°, whereas in the embodiment of FIG. 3, it is around 30°.

According to one advantageous embodiment, the bearing zone is surrounded or enclosed by the turned-up portion of the carcass-type reinforcement structure, which passes back a second time into the vicinity of the zone radially to the inside of the bead wire.

Advantageously, the thickness Emax of the anchoring closure zone is less than or equal to 1.5 times the diameter of the bead wire, and preferably less than or equal to 1.0 times the diameter of the bead wire.

Advantageously, said bead furthermore comprises a free zone, radially to the outside of the anchoring closure zone, the profile of which is defined on one hand by the axis alpha and on the other hand by an axis beta, substantially parallel to the axis alpha and radially external thereto.

Owing to the presence of this free zone, the radially outer portion of the bead is made less rigid, thus making the sidewall all the more flexible. Such a solution, which is used in a mounted assembly suitable for traveling over a given distance at reduced or zero pressure, makes it possible to increase the radius of action.

Said free zone preferably extends from a radially outer portion of the bearing zone towards the carcass-type reinforcement structure. It preferably comprises a thickness which is substantially constant over the width of its profile.

Also advantageously, the tire furthermore comprises an intermediate layer of rubber mix arranged between the reinforcement structure and the internal sealing rubber mix, the thickness of said layer being adapted such that the reinforcement structure travels, from the radially inner portion of the sidewall at least to mid-height thereof, substantially in the median zone of the sidewall.

Owing to an intermediate layer of this type, centering of the reinforcement structure substantially along the neutral axis is obtained. Such positioning permits excellent management of the stresses, and hence good endurance. Preferably, the positioning of the reinforcement structure along the neutral axis is extended radially externally beyond half the height of the sidewall and advantageously as far as the shoulder.

The thickness of the intermediate layer is advantageously greater in the radially is lower zone of the sidewall such that, radially externally and in the immediate proximity of the zone in which the reinforcement structure cooperates with the anchoring closure zone, said reinforcement structure is axially substantially aligned with a central zone of the bead wire.

Owing to such a configuration, the reinforcement structure forms, substantially at the level of the anchoring closure zone, an axial “protrusion” towards the outside, the effect of which is on one hand to accentuate the curvature of the reinforcement structure and on the other hand to prolong the path of this structure in the neutral zone. Furthermore, this pronounced curvature zone of the reinforcement structure makes it possible, in particular in reduced-pressure running mode, to obtain greater flexion of the sidewall of the tire.

Other characteristics and advantages of the invention will become apparent on reading the examples of embodiment of the tire according to the invention, which are given in non-limitative manner, with reference to the appended FIGS. 1 to 3, in which:

FIG. 1 depicts, in cross-section, a tire of known type, in particular the arrangement of the bottom zone of this tire;

FIG. 2 depicts, in cross-section, a tire according to the invention;

FIG. 3 depicts, in cross-section, a variant of a tire according to the invention.

In the present description, “radial structure” is understood to mean an arrangement at 90 degrees, but also, in accordance with custom, at an angle close to 90°.

“Sidewalls” refers to the portions of the tire, most frequently of low flexural strength, located between the crown and the beads. “Sidewall mix” refers to the rubber mixes located axially externally relative to the cords of the reinforcement structure of the carcass and to their bonding rubber. These mixes usually have a low elasticity modulus.

“Bead” refers to the portion of the tire adjacent radially internally to the sidewall.

“Elasticity modulus” of a rubber mix is understood to mean a secant modulus of extension obtained at a uniaxial deformation of extension of the order of 10% at ambient temperature.

FIG. 1 shows an example of a tire specially adapted for rolling in degraded mode of known type. According to this embodiment, the bead comprises anchoring of the reinforcement structure by turning up the latter around the bead wire and a bearing zone, adjacent to the bead wire. Furthermore, the zone of the bead located radially externally to the bead wire forms a triangle consisting of a rubber mix of high modulus. This triangle occupies a large portion of the bead and extends radially externally very far beyond the bead wire.

FIG. 2 shows, in cross-section, a tire 1 according to the invention. This tire comprises sidewalls 2 adjacent to beads 4. A crown 3, on which there is provided a tread, forms the connection between the sidewalls. The crown preferably comprises at least one reinforcement belt.

The tire comprises a carcass-type reinforcement structure 7, provided with reinforcing threads which are advantageously in a substantially radial configuration. This structure may be arranged continuously from one bead to the other, passing via the sidewalls and the crown, or alternatively it may comprise two or more parts, arranged for example along the sidewalls, without covering the entire crown.

The end portions 71 of the reinforcement structure 7 are located in the beads. Each bead comprises a seat 5 and an external flange 6 which are intended to come into contact with a suitable rim: in order to improve rolling in degraded mode, the bead seat 5 comprises a generatrix the axially inner end of which is located on a circle of diameter greater than the diameter of the circle on which the axially outer end is located. Each bead furthermore comprises a substantially circumferential anchoring zone 9 comprising a bead wire 8 against which the end portion 71 of the reinforcement structure is turned up. The bead wire 8 is intended on one hand to provide anchoring of the reinforcement structure 7 and on the other hand clamping of the tire when the latter is mounted on a suitable rim.

The bead also comprises a bearing zone 10 which is located axially externally to the bead wire and the profile of which forms a sort of elongated drop of water, the point of which is extended beneath the bead wire 8 and the body of which is radially adjacent and axially external to the bead wire. This bearing zone is formed of a rubber mix of substantially high modulus (preferably greater than 40 MPa, and possibly of more than 60 MPa). As illustrated, the bearing zone is preferably enveloped by the turned-up portion of the carcass-type reinforcement structure, which passes back a second time into the vicinity of the zone radially to the inside of the bead wire, after having enveloped the bearing zone 10.

The anchoring zone 9 of the reinforcement structure comprises an upturn of said reinforcement structure around said bead wire, radially to the inside thereof, from the axially inner side towards the side axially external to the bead wire.

Radially externally to the anchoring zone, there is an anchoring closure zone 11, substantially radially to the outside of the bead wire 8, the location of which is defined on one hand by a substantially axial imaginary bead wire axis At, passing substantially radially externally to said bead wire 8, and on the other hand an imaginary axis alpha, passing substantially radially externally to the bearing zone 10 and having an angle alpha of less than 500 and preferably less than 450, said angle alpha being measured between the bead wire axis and said axis alpha, in the clockwise direction. The modulus of the anchoring closure zone lies advantageously between 10 and 25 MPa, and preferably between 18 and 22 MPa. Furthermore, the thickness Emax of the anchoring closure zone 11 makes it possible to satisfy the following relationship: Emax≦1.5 D and more preferably Emax≦1.0 D.

The limitation of the angle alpha makes it possible to free part of the zone radially to the outside of the anchoring closure zone to create a free zone 12, the profile of which is defined on one hand by the axis alpha, and on the other hand by an axis beta, substantially parallel to the axis alpha, and radially external thereto. The free zone extends from a radially outer portion of the bearing zone towards the carcass-type reinforcement structure. It preferably comprises a thickness which is substantially constant over the width of its profile. The modulus of the free zone lies advantageously between 7 and 15 MPa.

According to another aspect of the invention, the angle opposed to the angle alpha is also limited, so as to enable the reinforcement structure to be positioned axially in radial alignment with the bead wire before leaving the bead for the sidewall. The reinforcement structure is therefore placed along the neutral axis. In order to prolong this favorable alignment in the sidewall, an intermediate layer 13, of rubber mix is arranged between the reinforcement structure and the internal sealing rubber mix, the thickness of said layer being adapted such that the reinforcement structure passes, from the radially inner portion of the sidewall at least as far as mid-height thereof, substantially in the median zone. The thickness of this intermediate layer is greater in the radially lower zone of the sidewall such that, radially externally and in the immediate proximity of the zone in which the reinforcement structure cooperates with the anchoring closure zone 11, said reinforcement structure is axially substantially aligned with a central zone of the bead wire 8. The modulus of the intermediate layer 15 lies advantageously between 5 and 8 MPa.

1. A tire for a vehicle wheel, comprising:
two sidewalls spaced apart axially from each other, joined at their radially outer portions by a crown zone provided on its radially outer portion with a circumferential tread;
beads, arranged radially to the inside of each of the sidewalls, each bead comprising a seat and an outer flange which are intended to come into contact with a suitable rim;
a reinforcement structure extending substantially radially from each of the beads, along the sidewalls, towards the crown zone;
at least one of said beads comprising:
a bead seat comprising a generatrix the axially inner end of which is located on a circle of diameter greater than the diameter of the circle on which the axially outer end is located;
a bead wire;
a zone for anchoring the reinforcement structure in said bead, comprising an upturn of said carcass-type reinforcement structure around said bead wire, radially to the inside thereof, from the axially inner side towards the side axially external to the bead wire;
a bearing zone, radially substantially close to and axially external to said bead wire, said bearing zone consisting of a rubber mix of substantially high modulus (preferably greater than 40 MPa);
an anchoring closure zone, substantially radially to the outside of the bead wire, the location of which is defined on one hand by an imaginary bead wire axis (At), which is substantially axial and passes substantially radially externally to said bead wire, and on the other hand an imaginary axis alpha, which passes substantially radially externally to the bearing zone and has an angle alpha of less than 50° and preferably less than 45°, said angle alpha being measured between the bead wire axis (At) and said axis alpha, in a clockwise direction.

2. The tire for a vehicle wheel according to claim 1, in which the thickness Emax of the anchoring closure zone is less than or equal to 1.5 times the diameter of the bead wire, and preferably less than or equal to 1.0 times the diameter of the bead wire.

3. The tire for a vehicle wheel according to claim 1, in which said bead furthermore comprises a free zone, radially to the outside of the anchoring closure zone, the profile of which is defined on one hand by the axis alpha, and on the other hand by an axis beta, substantially parallel to the axis alpha, and radially external thereto.

4. The tire for a vehicle wheel according to claim 3, in which said free zone extends from a radially outer portion of the bearing zone towards the carcass-type reinforcement structure.

5. The tire for a vehicle wheel according to claim 4, in which said free zone comprises a thickness which is substantially constant over the width of its profile.

6. The tire for a vehicle wheel according to claim 1, furthermore comprising an intermediate layer of rubber mix arranged between the reinforcement structure and the internal sealing rubber mix, the thickness of said layer being adapted such that the reinforcement structure passes, from the radially inner portion of the sidewall at least as far as mid-height thereof, substantially in the median zone of the sidewall.

7. The tire for a vehicle wheel according to claim 6, in which the thickness of the intermediate layer is greater in the radially lower zone of the sidewall such that, radially externally and in the immediate proximity of the zone in which the reinforcement structure cooperates with the anchoring closure zone, said reinforcement structure is axially substantially aligned with a central zone of the bead wire.

8. The tire for a vehicle wheel according to claim 2, in which said bead furthermore comprises a free zone, radially to the outside of the anchoring closure zone, the profile of which is defined on one hand by the axis alpha, and on the other hand by an axis beta, substantially parallel to the axis alpha, and radially external thereto.
